(19) United States
(12) Patent Application Publication
(10) Pub. No.: US 2026/0114491 A1
(43) Pub. Date: Apr. 30, 2026

(54) BELT CONVEYOR PROVIDED WITH A ROLLING DEVICE FOR TRANSPORTING AND ROLLING FOOD PRODUCTS

(71) Applicant: ELCAT S.R.L., SANFRE'(CN) (IT)

(72) Inventor: Enrico TESTA, SANFRE'(CN) (IT)

(73) Assignee: ELCAT S.R.L., SANFRE'(CN) (IT)

(21) Appl. No.: 19/370,366

(22) Filed: Oct. 27, 2025

(30) Foreign Application Priority Data
Oct. 29, 2024 (IT) 102024000024165

(51) Int. Cl. A23P 30/00; B65G 39/20

(52) U.S. Cl. CPC A23P 30/00; B65G 39/20

(57) ABSTRACT

A belt conveyor has a frame carrying a plurality of guide rollers which are rotatable about horizontal axes parallel to one another, and are coupled to a transport belt for transporting food products from an inlet to an outlet; the conveyor has a rolling device with a support structure rotatable relative to the frame between a first condition in which the support structure is lowered, and a second condition in which the support structure is tilted upwards and the transport belt is folded onto two guide cylinders so as to surround a gap where the food products are rolled; in the second condition, the transport belt is coupled onto guide rollers mounted on the support structure along rotation axes which are arranged along an arc of circumference.

### CROSS-REFERENCE TO RELATED APPLICATIONS

This patent application claims priority from Italian patent application no. 102024000024165 filed on Oct. 29, 2024, the entire disclosure of which is incorporated herein by reference.

### TECHNICAL FIELD

The present invention relates to a belt conveyor provided with a rolling device for transporting and rolling food products.

### BACKGROUND

As is known, many food products are in the form of slices (e.g., cured meats, cold cuts, cheese, etc.) or in the form of sheets (e.g., piadinas (Italian flatbread), dough sheets, etc.). In this context, it is known to use rolling devices which allow to roll such products, both on themselves and around other food products used to form an inner core. In general, the need is felt to integrate such rolling devices into belt conveyors, so as to achieve the rolling during the transport of food products towards an outlet station, for example towards a packaging station.

Examples of this type are shown in the prior documents EP0454202A1 and IT102012902096008 which show solutions corresponding to the preamble of the appended claim 1. Such solutions include a transport belt having, at the conveyor outlet, a belt portion wound on idle rollers mounted on a support structure which can rotate about a horizontal tilting axis. The upward and backward tilting of this support structure about this axis allows the corresponding belt portion to be bent backwards so as to cause it to wrap up two guide cylinders which are arranged along opposite edges of the conveyor in coaxial and spaced apart positions. The tilted belt portion substantially closes from above the gap existing axially between the two cylinders. In this position, thanks to the continuous advancement of the transport belt, the food products enter the aforementioned gap and there they are naturally rolled (i.e., due to the advancement of the transport belt, without needing to stop the conveyor and without needing to carry out additional operations). After having tilted the aforementioned support structure forward again, the already rolled food products are transferred on the transport belt on an outlet conveyor arranged downstream.

The known solutions of the known type just described are barely satisfactory, due to some drawbacks.

First, the idle rollers mounted on the support structure being tilted have a relatively small radius, for reasons related to dimensions. In practice, this configuration forms a series of relatively sharp folds along the path formed by the transport belt: over time, it is apparent that the transport belt is subject to undesired cracks, essentially due to cyclic fatigue stresses presumably caused by the number and extent of these folds during the advancement.

At the same time, the tilting support structure has relatively large dimensions in the radial direction relative to its horizontal tilting axis, and these dimensions negatively impact on the maximum horizontal length that the conveyor has beyond the two guide cylinders, towards the outlet conveyor.

Furthermore, considering that the transport belt changes its path in space when the above-mentioned support structure tilts, it is generally necessary to provide a recovery system to compensate for this change in the path along the conveyor and, therefore, maintain the conveyor belt always tensioned, however in the known solutions described above this recovery system is relatively complex.

The object of the present invention is, therefore, to provide a conveyor belt which allows transporting and rolling sliced food products and allows at least part of the drawbacks set forth above to be solved in a simple and cost-effective manner.

### SUMMARY

According to the present invention, a belt conveyor is provided, as claimed in claim 1.

The dependent claims define preferred embodiments according to the present the invention.

### BRIEF DESCRIPTION OF THE DRAWINGS

In order to better understand the present invention, some embodiments thereof will now be described, by way of mere non-limiting example, with reference to the accompanying drawings, wherein:

FIGS. 1 and 2 illustrate, in perspective, a preferred embodiment of the conveyor belt according to the present invention in two different operational configurations;

FIG. 3 is a side view of the belt conveyor in the operational configuration of FIG. 2;

FIG. 4 is similar to FIG. 2 and shows the belt conveyor with parts removed for clarity; and

FIGS. 5 to 8 are schematic side views showing steps for rolling a food product transported by the belt conveyor.

### DESCRIPTION OF PREFERRED EMBODIMENTS

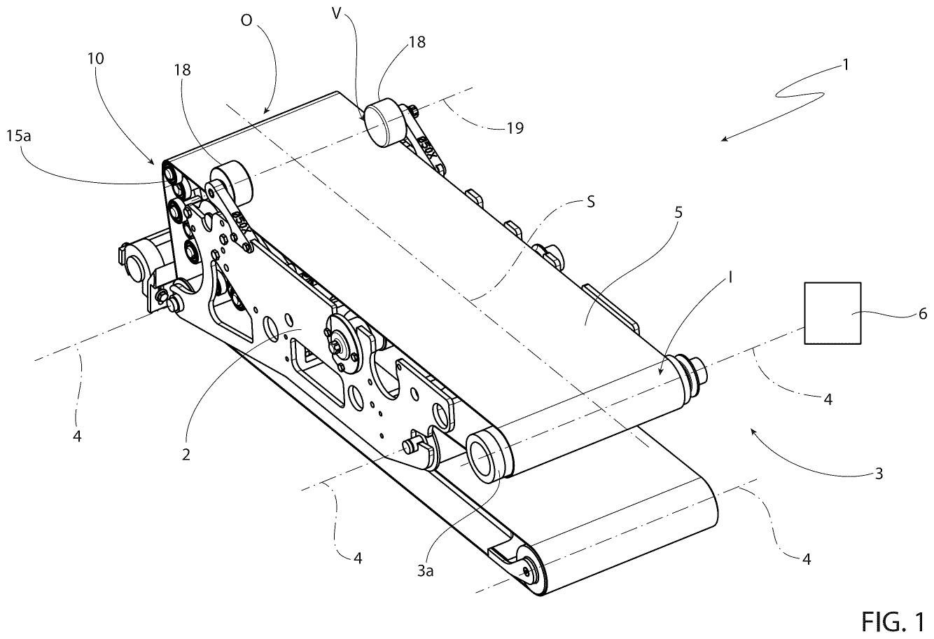

In FIG. 1, reference numeral 1 identifies a belt conveyor comprising a frame 2, a plurality of guide rollers 3 carried by the frame 2 and rotatable about respective rotation axes 4, horizontal and parallel to each other, and a transport belt 5 which is wound on the guide rollers 3. The guide rollers 3 comprise a roller 3a, which is motorized by means of an actuator device 6 (schematically illustrated) of known type and not described in detail, so as to make the transport belt 5 to advance about the guide rollers 3 along a corresponding path. Preferably, the rotation axis 4 of the roller 3a is fixed relative to the frame 2.

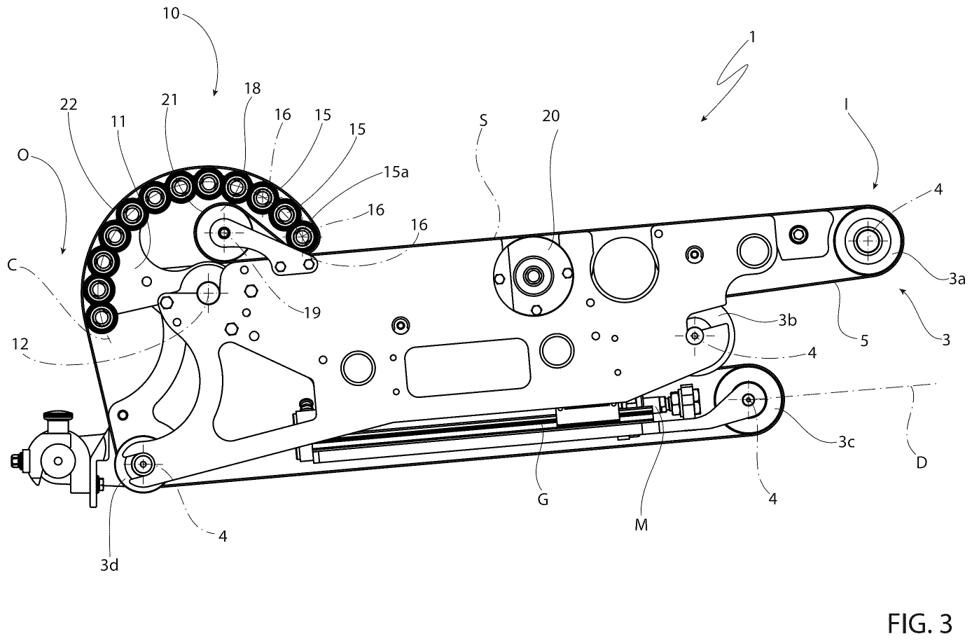

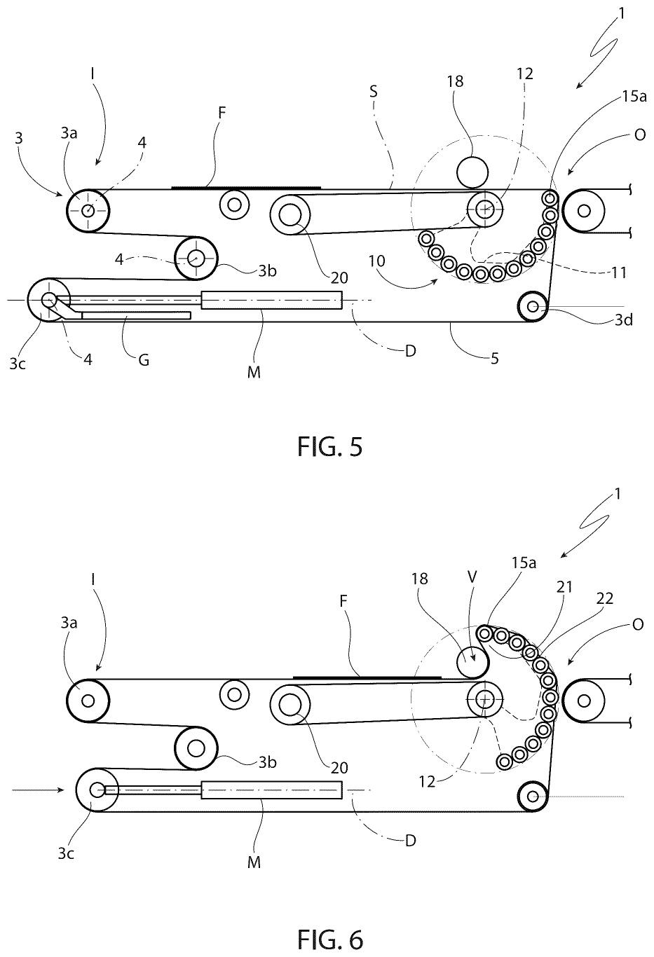

Referring to FIG. 3, the path of the transport belt 5 has an upper section S for transporting, in use, food products F (FIG. 5) along a rectilinear, preferably horizontal, advancement direction from an inlet I to an outlet O of the conveyor 1. The food products F are defined by sliced products, such as cured meats or cheese, or by products in the form of sheets, such as piadinas, dough sheets, etc.

Preferably, at the inlet I of the conveyor 1, the guide rollers 3 comprise the roller 3a, a roller 3b, the rotation axis 4 thereof being also fixed relative to the frame 2, and a roller 3c which is a tensioning roller, the rotation axis 4 thereof being movable relative to the frame 2 so as to compensate for variations in the path of the transport belt 5. Preferably, at the rollers 3a, 3b, and 3c, the path of the transport belt 5 has an S-shape; in particular, the roller 3b is arranged vertically in an intermediate position between the rollers 3a and 3c and, in the horizontal direction, is arranged in a position closer to the outlet O compared to the rollers 3a and 3c.

Preferably, among all guide rollers 3 mounted on the frame 2, the roller 3c is the only movable roller for carrying out a tensioning function. More preferably, the roller 3c is coupled to a guide G of the frame 2 so as to slide along a rectilinear direction D; the latter is preferably horizontal and parallel to the upper section S of the path of the transport belt 5.

In particular, the roller 3c moves in response to the thrust of an actuator M which is carried by the frame 2 and extends along the direction D, and is defined by an electrically- or pneumatically-driven thrust cylinder, for example.

At the outlet O of the conveyor 1, the guide rollers 3 comprise a roller 3d, the rotation axis 4 thereof being fixed relative to the frame 2. Preferably, the rollers 3d and 3c are aligned to each other in the horizontal direction.

The conveyor 1 further comprises a rolling device 10 so as to be able to roll food products F, both on themselves and around other food products (not illustrated) used to form a core internal to the rolled product.

The device 10 comprises a support structure 11 which is coupled to the frame 2 so as to be able to rotate about a tilting axis 12 parallel to the rotation axes 4, and supports a plurality of guide rollers 15 rotatable about respective rotation axes 16 which are also parallel to the rotation axes 4. The guide rollers 15 are coupled to the structure 11 so as to rotate idle. More in particular, the rotation axes 16 are fixed relative to the structure 11; the outer periphery of the guide rollers 15 could possibly be rubberized.

Referring to FIG. 1, the device 10 further comprises two guide cylinders 18 which are arranged above the transport belt 5 along opposite edges of the upper section S of its path and are coaxial to each other along an axis 19 fixed relative to the frame 2 and parallel to the rotation axes 4 and 16. In this manner, the guide cylinders 18 are spaced axially apart by a gap V. Furthermore, preferably the guide cylinders 18 are mounted so as to rotate idle about the axis 19 independently of each other.

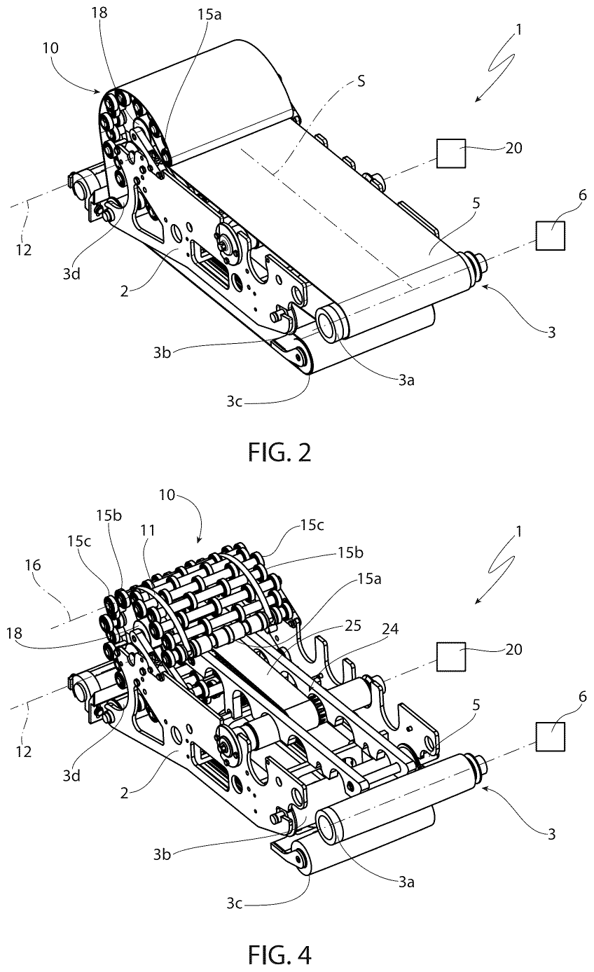

The device 10 further comprises an actuator device 20 (schematically illustrated in FIG. 4) controlled to tilt the structure 11 at the tilting axis 12 between:
a first operational condition (FIGS. 1 and 5) in which the structure 11 is lowered, therefore the transport belt 5 is stretched between the inlet I and the outlet O along the upper section S of its path and, in particular, assumes a rectilinear profile, and a second operational condition (FIGS. 2, 3, and 7) in which the structure 11 is tilted upwards, therefore the transport belt 5 has a belt portion 21 which wraps up and rests on the side surface of the guide cylinders 18, therefore has a downward-concave profile and closes the gap V from above, and a belt portion 22 which wraps up and rests on the guide rollers 15.

In particular, as illustrated in FIG. 4, the actuator device 20 drives the structure 11 through a transmission 24 which comprises a transmission belt 25 wound on two pulleys coupled to the frame 2, for example.

As mentioned above, the variation in the path of the transport belt 5 during the tilting of the structure 11 is compensated by the roller 3c shifting relative to the frame 2. The actuator M exerts a thrust maintaining the transport belt 5 tensioned, in particular during the tilting of the structure 11. For example, the actuator M is driven in response to a signal detected by at least one sensor (not illustrated) and indicative of the tension of the transport belt 5.

More preferably, the tensioning is carried out by an actuator M defined by a pneumatic cylinder having a rear chamber connected to a not illustrated compressed air source: the inner pressure of this rear chamber is adjustable (in order to vary the thrust acting on the roller 3c) by acting on a pneumatic resistance or a proportional valve (not illustrated) interposed between the cylinder and the compressed air source. The pressure can be set to a fixed value or modulated during the operation of the conveyor 1, in particular based on the position of the structure 11 about the axis 12. The setting and/or modulation of the pressure in the rear chamber of the pneumatic cylinder are carried out with such control logics to limit the stresses on the mechanical members provided to make the transport belt 5 to advance based on the type of the processed food product.

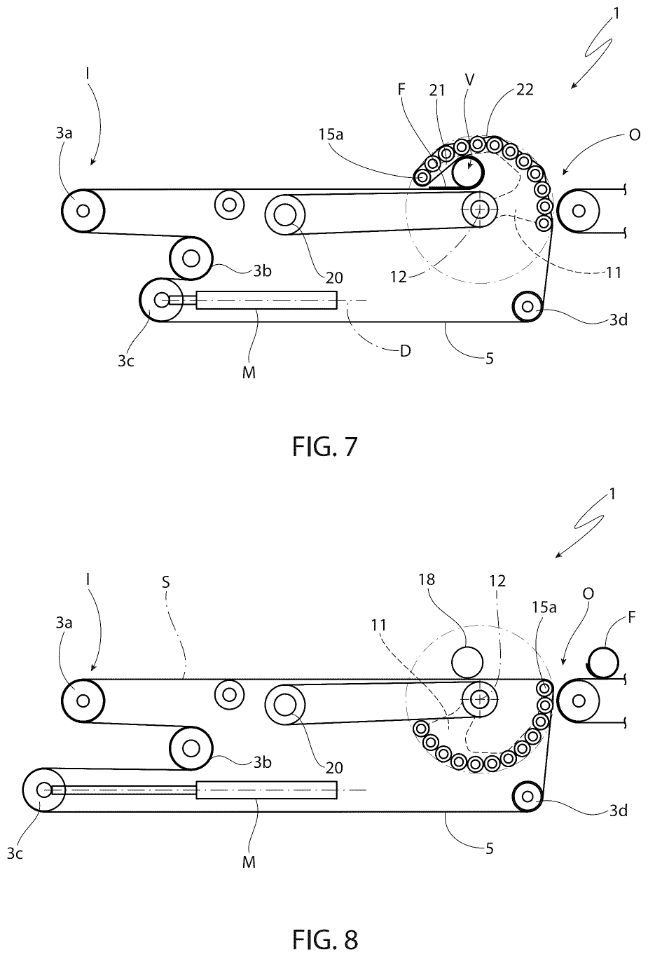

Then, referring to the accompanying figures, the guide rollers 15 comprise at least one roller 15a which is arranged at an end of the arc of circumference C, and: in the first operational condition, is located at the outlet O and deflects the transport belt 5 downwards, in particular towards the roller 3d (FIG. 5), and in the second operational condition, defines a deflection between the belt portions 21 and 22 (FIG. 7).

According to the present invention, referring to FIG. 3, the rotation axes 16 are arranged in positions aligned to one another along an arc of circumference C. In particular, the latter has a center which coincides with the tilting axis 12, i.e. lies on the latter.

Thus, in the second operational condition, the guide rollers 15 deflect the belt portion 22 downwards along an approximately curved trajectory about a center of the arc of circumference C and, therefore, with a radius of curvature defined by the sum of the radius of the arc of circumference C and of the radius of the guide rollers 15. The term “approximately” used above is due to the fact that, between each pair of adjacent guide rollers, the belt portion 22 has in any case a rectilinear profile for short sections.

Preferably, the number, relative position and radius of the guide rollers 15 are such that no gap is left between the guide rollers 15 along the arc of circumference C: in other words, as shown in FIG. 3, the guide rollers 15 extend continuously along the entire arc of circumference C. In particular, the arc of circumference C has an angular extension greater than 0° and less than or equal to 150°, and the number of guide rollers 15 for each side is advantageously greater than or equal to 12.

In the preferred non-limiting solution being illustrated, at each of the opposite sides of the structure 11, the guide rollers 15 comprise two sets of rollers indicated in FIG. 4 by 15b and 15c, respectively.

For each of both opposite sides of the structure 11, the rollers 15b and 15c are arranged in alternating positions to each other along the arc of circumference C and are axially offset from each other: in other words, the rollers 15b are aligned to one another so as to lie on a first vertical plane, and the rollers 15c are aligned to one another so as to lie on a second vertical plane which is parallel to and spaced apart from the first vertical plane. In FIG. 4, for example, the rollers 15c are shown in a more external axial position than the rollers 15b, for each of both opposite sides of the structure 11.

Still considering each of both opposite sides of the structure 11, the rollers 15b are spaced apart from one another along the arc of circumference C, and similarly the rollers 15c are spaced apart from one another along the arc of circumference C. At the same time, the rollers 15b and 15c have respective outer peripheries which are axially facing each other, so as not to leave any gap along the arc of circumference C, as already indicated above in a general manner.

The arc-of-circumference configuration about the tilting axis 12 allows the radii of curvature of the belt portion 22 to be increased and, at the same time, the dimensions to be reduced. In this regard, by arranging the guide rollers 15 on the structure 11 in positions equally spaced apart from the tilting axis 12, gaps at the outlet O of the conveyor 1 in the second operational configuration (FIG. 7) and during the rotation of the structure 11 (FIG. 6) are prevented.

Referring again to FIG. 3, preferably the tilting axis 12 is arranged below the upper section S of the path of the transport belt 5, in a position vertically aligned with the guide cylinders 18. This positioning allows the dimensions between inlet I and outlet O to be further reduced. In particular, in the horizontal direction, the tilting axis 12 is arranged in an intermediate position between the axis 19 and the outlet O of the conveyor 1.

Advantageously, the device 10 rolls the food products F while transporting them, i.e. without stopping the transport belt 5, as schematized in FIGS. 5 to 8. In particular, when a new food product F has entered on the conveyor 1 and advances towards the gap V provided between the guide cylinders 18 (FIG. 5), the actuator device 20 is controlled so as to tilt the structure 11 to the second operational condition (FIG. 6); accordingly, the food product F enters the space V and there it is naturally rolled thanks to the position and curvature of the belt portion 21 and thanks to the simultaneous advancement of the transport belt 5 (FIG. 7); once the rolling is finished, the actuator device 20 is controlled to tilt backwards the structure 11 towards the first operational position, so as to continue the advancement of the already rolled food product F towards the outlet O (FIG. 8). During the tilting of the structure 11, the actuator M is also controlled to maintain the transport belt 5 properly tensioned, as already explained above.

Based on the foregoing, the advantages of the conveyor 1 become evident. In particular, as set forth above, the arc-of-circumference configuration of the guide rollers 15 allows to have a relatively large radius of curvature along the belt portion 22 to reduce the risks of cracks in the transport belt 5, at the same time, however, it allows the overall dimensions of the device 10 and, therefore, of the conveyor 1 as a whole to be reduced.

In general, the dimensions are reduced thanks to the peculiar arrangement of all components of the device 10. Furthermore, the system adopted for compensating the variations in the path and maintaining the transport belt 5 tensioned is relatively simple and compact. Other advantages will become evident to a person skilled in the art from the features that have been described above referring to the accompanying Figures. Finally, it is apparent that modifications and variations can be made to the conveyor 1 which do not depart from the scope of protection of the present invention, as defined in the appended claims.

For example, the number and arrangement of the guide rollers 3 could be different, as well as the structure 11 could be tilted through different mechanisms and/or transmissions, compared to what illustrated and described above.

Finally, on each side of the structure 11, the rollers 15 could be arranged in radially closer positions to one another, without having axially offset rollers 15b and 15c.

What is claimed is:

1. A belt conveyor comprising:
a frame;
first guide rollers, carried by said frame and rotatable respectively about first rotation axes, horizontal and parallel to one another; said first guide rollers comprising a motorized roller;
a transport belt coupled to said guide rollers so as to form a path comprising an upper path section for transporting food products from an inlet to an outlet;
a rolling device for rolling said food products, the rolling device comprising:
a) a support structure rotatable relative to said frame about a tilting axis parallel to said first rotation axes;
b) second guide rollers, carried by said support structure and rotatable respectively about second rotation axes, parallel to said first rotation axes;
c) two guide cylinders, which are arranged on said transport belt at said upper path section, are coaxial and are spaced axially apart by a gap;
d) an actuator device controlled to tilt said support structure between a first condition and a second condition, in which said support structure is tilted upwards relative to the first condition, and said transport belt has
(1) a first belt portion coupled onto said guide cylinders so as to close said gap from above,
(2) a second belt portion coupled onto said second guide rollers;
characterized in that said second rotation axes are arranged along an arc of circumference, whereby in the second condition said second belt portion is deflected by said second guide rollers along an approximately curved trajectory about a center of said arc of circumference.

2. The belt conveyor according to claim 1, wherein the center of said arc of circumference coincides with said tilting axis.

3. The belt conveyor according to claim 1, wherein the number, position and radius of said second guide rollers are such that no gap is left between said guide rollers along said arc of circumference.

4. The belt conveyor according to claim 3, wherein said second guide rollers comprise a first set of rollers and a second set of rollers at each of the opposite sides of said support structure; and wherein the rollers of the first set are in positions alternating with the rollers of the second set along said arc of circumference, and are in positions axially offset from the rollers of the second set.

5. The belt conveyor according to claim 4, wherein the rollers of the first set and the rollers of the second set have respective outer peripheries which are axially facing each other, so as not to leave any gap along said arc of circumference.

6. The belt conveyor according to claim 1, wherein said tilting axis is arranged in a vertically aligned position below said guide cylinders.

7. The belt conveyor according to claim 6, wherein said tilting axis, in horizontal direction, is arranged between an axis of said guide cylinders and said outlet.

8. The belt conveyor according to claim 1, wherein said first guide rollers comprise a single tensioning roller, movable relative to said frame to compensate for variations in the path of said transport belt during the tilting of said support structure.

9. The belt conveyor according to claim 8, wherein said tensioning roller is movable along a rectilinear direction relative to said frame.

10. The belt conveyor according to claim 9, wherein said tensioning roller is movable relative to said frame under the thrust of an actuator.
